(19) United States
(12) Patent Application Publication
(10) Pub. No.: US 2012/0319909 A1
(43) Pub. Date: Dec. 20, 2012

(54) ANTENNA DEVICES AND PORTABLE ELECTRONIC DEVICES COMPRISING SUCH ANTENNA DEVICES

(76) Inventors: Stefan Irmscher, Taby (SE); Andrei Kaikkonen, Jarfalla (SE); Peter Lindberg, Uppsala (SE)

(21) Appl. No.: 13/599,855

(22) Filed: Aug. 30, 2012

Related U.S. Application Data
(63) Continuation of application No. PCT/EP2010/055462, filed on Apr. 23, 2010.

(51) Int. Cl. H01Q 5/01

(52) U.S. Cl. 343/749

(57) ABSTRACT

An exemplary embodiment of an antenna device generally includes a radiator structure with at least one first radiator element. The antenna device also includes a first feeding connection coupling the radiator structure to a first radio circuit for operation in a first frequency band. The antenna device further includes a second feeding connection coupling the radiator structure to a second radio circuit for operation in a second frequency band. A set of capacitors is connected to the radiator structure. This set includes at least one capacitor where a first end of each capacitor in the set is connected to the radiator structure and a second end is provided at ground potential, at least for the first frequency band. The sum of the values of the capacitors in the set is below 15 picofarads.

### CROSS-REFERENCE TO RELATED APPLICATION

This application is a continuation of PCT International Patent Application No. PCT/EP2010/055462 filed Apr. 23, 2010, published as WO2011/131247. The entire disclosure of the above application is incorporated herein by reference.

### FIELD

The present disclosure relates generally to antenna devices for use in a portable radio communication devices, such as mobile phones.

### BACKGROUND

This section provides background information related to the present disclosure which is not necessarily prior art.

Internal antennas have been used for some time in portable radio communication devices. There are a number of advantages connected with using internal antennas, of which can be mentioned that they are small and light, making them suitable for applications wherein size and weight are of importance, such as in mobile phones.

The demand for various types of communication needed in a portable radio communication device is increasing. Today, it is often necessary to cover several cellular frequency communication bands, near field communication (NFC) (e.g., Bluetooth), positioning (e.g., global positioning system (GPS)), and radio (e.g., frequency modulation (FM)). Examples of other types of possible communications include television such as DBM.

But portable radio communication devices are getting increasingly smaller, and thus the space available for different frequency bands is getting more and more limited. There is therefore a need for combining the radiator elements of an antenna device for operation in different frequency bands and for different types of radio communication technologies. This combination should also allow simultaneous use of the radiator elements, which is not so easy to do, since they will often interfere with each other. These devices do in many cases not allow provision of resonance in the same band.

There is therefore a need for providing an antenna device which allows the simultaneous use of the same radiator element for simultaneous operation in different frequency bands and different communication technologies.

### SUMMARY

This section provides a general summary of the disclosure, and is not a comprehensive disclosure of its full scope or all of its features.

According to various aspects, exemplary embodiments are disclosed of antenna devices. In an exemplary embodiment, an antenna device generally includes a radiator structure with at least one first radiator element. The antenna device also includes a first feeding connection coupling the radiator structure to a first radio circuit for operation in a first frequency band. The antenna device further includes a second feeding connection coupling the radiator structure to a second radio circuit for operation in a second frequency band. A set of capacitors is connected to the radiator structure. This set includes at least one capacitor where a first end of each capacitor in the set is connected to the radiator structure and a second end is provided at ground potential, at least for the first frequency band. The sum of the values of the capacitors in the set is below 15 picofarads.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front view of one exemplifying portable radio communication device according to an exemplary embodiment;

FIG. 2 is a sectional view of the portable radio communication device shown in FIG. 1;

FIG. 3 schematically shows an antenna device according to a first exemplary embodiment together with two radio circuits;

FIG. 4 schematically shows some parts of the antenna device according to the first exemplary embodiment together with the radio circuits on the circuit board as well as a ground plane of the circuit board;

FIG. 5 schematically shows an antenna device according to a second exemplary embodiment together with two radio circuits; and

FIG. 6 schematically shows some parts of the antenna device according to the second exemplary embodiment together with the radio circuits on the circuit board and ground plane.

### DETAILED DESCRIPTION

Example embodiments will now be described more fully with reference to the accompanying drawings.

Exemplary embodiments are disclosed of antenna devices and portable radio communication devices including such antenna devices. An exemplary embodiment is generally directed towards an antenna device and a portable radio communication device including an antenna device, where the antenna device may be supposed to simultaneously receive and/or transmit radio signals in a first and a second operating frequency band.

Advantageously, exemplary embodiments may provide an internal antenna device for use in a portable radio communication device, which combines simultaneous use in two different frequency bands with a small size. Aspects of the present disclosure are based on the realization that a radiator structure being connected to the first ends of a set of capacitors, the second ends of which are provided at ground potential at least for a first frequency band, and where the sum of the values of the capacitors in the set is below 15 picofarads (pF), provides adequate performance in the two bands together with a small size.

In an exemplary embodiment, there is provided an antenna device for operation in at least a first lower and a second higher frequency band. The antenna device comprises a radiator structure including at least one first radiator element and having a first and a second end. The antenna device also includes a first feeding connection for coupling the radiator structure to a first radio circuit for operation in the first frequency band. The antenna device further includes a second feeding connection for coupling the radiator structure to a second radio circuit for operation in the second frequency band. A set of capacitors are connected to the radiator structure and including at least one capacitor, where a first end of each capacitor in the set is connected to the radiator structure and a second end is provided at ground potential, at least for the first frequency band, and the sum of the values of the capacitors in the set is below 15 pF.

Exemplary embodiments are also directed towards a portable radio communication device comprising in its interior such an antenna device, a circuit board and a first and a second radio circuit connected to the antenna device.

Exemplary embodiments of the antenna devices disclosed herein provide operation with fair performance in both a first lower frequency band and a second higher frequency band. This is furthermore done with a small amount of electrical components and radiator elements, making the antenna device economical and easy to produce. The size can furthermore also be small.

FIG. 1 shows a front view of a portable radio communication device 10, such as a mobile phone. The portable radio communication device 10 can however be another type of device, such as a lap top computer, a palm top computer, or an electronic organizer such as a personal digital assistant (PDA). The device 10 is, as an example, provided with a speaker 12 placed close to an upper end of the device 10, a keypad 14 placed close to a lower end of the device 10, and a display 16 in-between the speaker 12 and the keypad 14. These are here provided on the casing of the device 10. It should be realized that the device may just as well be provided without a display, speaker, and/or keypad. The device 10 is also provided with at least one antenna. The antennas of this present disclosure are provided inside the interior of the device 10.

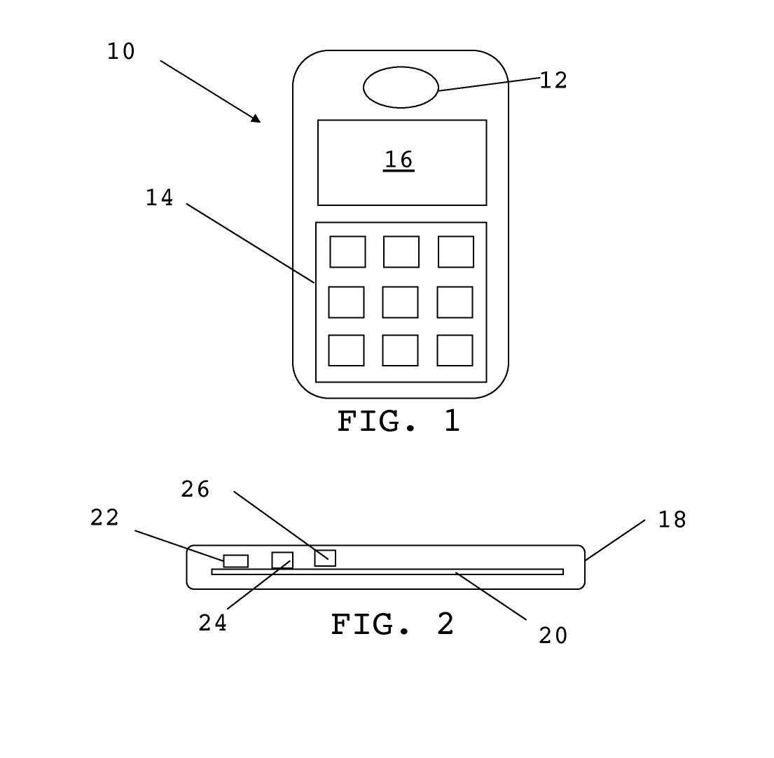

FIG. 2 shows a schematic side view of the device 10, which is a cross section through the casing 18. In order to clarify the description, only elements that are relevant for understanding the disclosed exemplary embodiments of the antenna devices are included. Thus, a number of units in the device have here been omitted, like for instance the display, the keypad, and the speaker shown in FIG. 1.

As shown in FIG. 2, the device 10 includes a circuit board 20 on which an antenna device 22 is mounted. On the board 20, there is also a first radio circuit 24 and a second radio circuit 26. In this example, the first radio circuit 24 is an FM radio circuit, and the second radio circuit 26 is a cellular radio circuit. The circuit board 20, which may be a multi-layer PCB (printed circuit board), furthermore includes a ground plane (not shown).

FIG. 3 schematically shows the antenna device according to a first exemplary embodiment in the form of a dashed box 22, including radiator elements and a number of electric components in the form of filters, capacitors, and matching units. The connection of the antenna device to the first and the second radio communication circuits 24 and 26 is also shown.

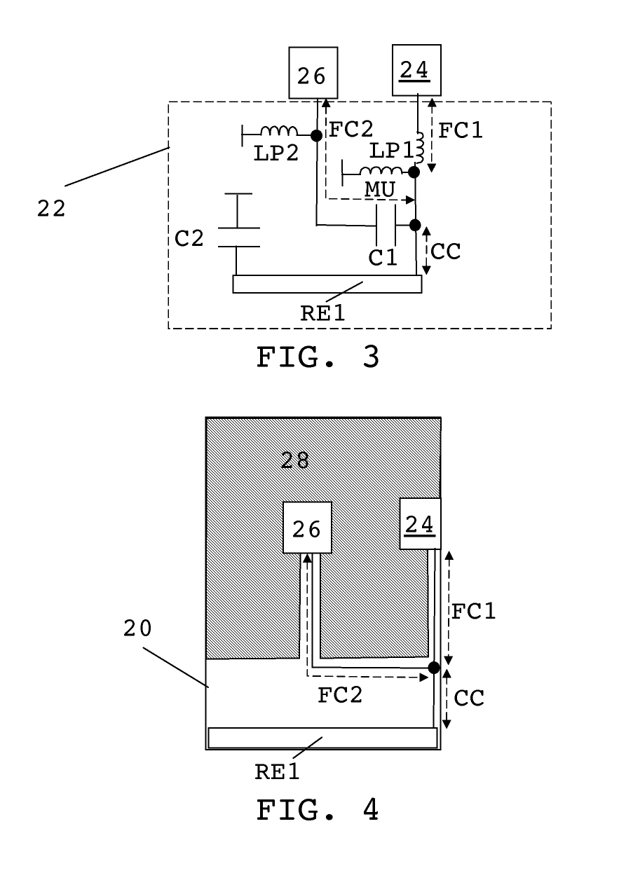

FIG. 4 schematically shows the radiator elements of the antenna device according to the first exemplary embodiment being connected to the radio circuits 24 and 26. But in FIG. 4, the above mentioned electric components have been omitted in order to provide a better understanding of the physical placing of the radiator elements on the board 20. In FIG. 4, the placing of the ground plane is also shown.

With continued reference to FIG. 4, the antenna device 22 is provided for operation in at least a first lower frequency band and a second higher frequency band. The the lower frequency band in this exemplary embodiment is the FM frequency band, which is 88-108 Megahertz (MHz) in Europe and 76-110 MHz in the USA. The higher frequency band is a cellular frequency band, for example, the GSM 850 or 900 band. It should be realized that it is possible to operate the antenna device in other bands, such as GSM 1800 and 1900 MHz in for example GSM, WCDMA, or LTE, as well as in Bluetooth and GPS bands. One of the bands could also be a DVB band in about 400-800 MHz.

The antenna device according to the first exemplary embodiment is provided for coupling of a radiator structure to two separate radio circuits. Therefore, the antenna device includes a first feeding connection FC1 between the radiator structure and the first radio circuit 24. The antenna device also includes a second feeding connection FC2 between the radiator structure and the second radio circuit 26.

In this first exemplary embodiment, the radiator structure is solely made up of a first radiator element RE1 and has a first and a second end, where the first end is to receive radio signals. The first feeding connection FC1 here includes a first low pass filter LP1 connected between the radiating structure and the first radio circuit 24. This low pass filter LP1 is in this first embodiment provided as an inductor, for example of 100 nanoHenries (nH), connected in series between the first end of the radiator structure and the first radio circuit 24. This filter has the function to block signals in and above the second frequency band and to allow signals in and below the first frequency band to pass. There is furthermore also a matching unit MU, here in the form of an inductance, for example having a value of above 200 nH. This is provided for matching the radiating element of the antenna device to the frequencies used in the first frequency band. The matching unit is connected between the first end of the radiator structure and ground.

The second feeding connection FC2 includes a series-connected first capacitor C1 between the first end of the radiator structure and the second radio circuit 26. The first capacitor C1 thus has a first end coupled to the radiator structure and a second end coupled to the second radio circuit 26. The first capacitor C1 allows signals in the second frequency band to pass through the second feeding connection FC2 while assisting in stopping signals in the first frequency band from reaching the second radio communication circuit 26. The second feeding connection also includes a second low pass filter LP2 connected between the second feeding connection and ground. More particularly, it is connected between the second end of the first capacitor C1 and ground. This second low pass filter LP2 is also provided in the form of an inductor, typically of about 10 nH, in order to provide ground for the first frequency band and also in order to provide electrostatic discharge (ESD) protection of the antenna device. Thus, the provision of the second low pass filter LP2 ensures that the second end of the first capacitor C1 is provided at ground potential for the first frequency band. But in the second frequency band and at higher frequencies it is not. Through the provision of the second low pass filter LP2, the first capacitor C1 becomes a shunt capacitor for the first frequency band but a series capacitor for the second frequency band. The first capacitor C1 may furthermore act as a pure conductor for these higher frequencies, i.e., act as a short-circuit.

The first radiator element RE1 of the radiator structure is shaped for providing resonance. It may as an example be shaped as a planar rectangular element, which provides resonance with the help of the matching unit MU for the first frequency band. The first end of radiator structure, which is also the first end of the first radiator element RE1 is coupled to the two feeding connections FC1 and FC2 via a common feeding connection CC, here in the form of a thin conductor, and at the second end, which is also the second end of the first radiator element RE1, optionally coupled to ground via a second capacitor C2. This second capacitor C2 is designed to ground the second end of the structure for signals in the second and higher frequency bands. The common feeding connection CC is provided at right angles to the longitudinal extension of the radiator structure.

As can be seen in FIG. 4, the radiator structure is here essentially provided along the whole length of a first, short side of the circuit board 20, and the area where it is provided does optionally not have any ground plane, while the common feeding connection is provided at right angles to this first side and the radiator structure and stretches along a second, long side of the circuit board. In the first exemplary embodiment, there is, as was mentioned above, only one radiator element in the structure and it stretches along the full length of the first short side. This means that the radiating element operating in the first frequency band stretches along the whole first short side, is being fed along the second long side and is thus provided above a part of the circuit board optionally lacking ground plane. This improves the performance if operating in an FM band.

In the first exemplary embodiment, the whole radiator structure is used in both bands simultaneously. The second optional capacitor C2 is here a shunt capacitor for the radiator structure and also makes the radiator structure electrically floating in the first frequency band. It is thus not connected to any potential at this point. This means that the radiator structure in this first exemplary embodiment functions as a monopole element in the first frequency band, which is matched to an operating frequency by the matching unit MU, i.e., it is matched for obtaining resonance in this range. The first low pass filter LP1 furthermore makes the first capacitor C1 a shunt capacitance in relation to the first frequency band and also provides ESD protection and stops radio signals in the first frequency band from reaching the second radio circuit. In this way, radio signals can be received and transmitted to and from the first radio circuit 24 via the radiator structure in the first frequency band, where the first low pass filter LP1 ensures that signals in the second and higher frequency bands do not reach the first radio circuit 24.

The first radio circuit 24 may here include an amplifier, for example, a low noise amplifier for amplifying the radio signals in the first frequency band. Because of this, the radiator structure with components and this amplifier may be considered to be a so-called active antenna. The radiator structure, shunt capacitors at the first and second ends, and the inductor of the matching unit may here be selected to provide a resonance circuit having an impedance close to the optimal noise impedance Sₒₚₜ of the low noise amplifier at the first frequency band. The impedance of the radiator structure and the impedance of the amplifier may therefore be matched to each other at an impedance considerably higher than the impedance of 50 ohms (S2) normally provided for electrical circuits.

The shunt capacitances give a slight degradation of the performance in the first frequency band compared to operation without the capacitors. But this is acceptable considering the fact that at the same time it is possible to combine the antenna device with use also for the second frequency band. If the sum of the shunt capacitances connected to the radiator structure is 15 pF a 5 decibel (db) eae (effective antenna efficiency) performance degradation is obtained, while if the sum is 10 pF a 3 dB performance degradation is obtained. These values are acceptable in most applications.

It can therefore be seen that the shunt capacitors connected to the radiator structure should together have a capacitance below 15 pF. This means that the sum of the capacitances of these capacitors have to be below this value.

When the second capacitor C2 is present, the radiator structure of the first exemplary embodiment is in the example shown in FIG. 3 provided as a loop or rather a half loop antenna when operating in the second frequency band. This is because in this exemplary embodiment the second end of the radiator structure is grounded. If the second capacitor has another placing along the structure, the structure may instead act as a PIFA or IFA antenna in the second frequency band, while if the second capacitor is missing the structure will function as a monopole antenna also in the second band.

In the second frequency band, the radiator structure is in this example in FIG. 3 thus made to operate as a magnetic dipole for radio signals transmitted to and from the second radio circuit 26. In a similar way, the combination of first capacitor and second low pass filter here ensures that signals in the first frequency band do not reach the second radio circuit.

There are number variations that are possible to make of the first embodiment. It is possible that the matching unit is omitted. In this case, it is possible that the first radio circuit may need to include an amplifier. It is here also possible that the second capacitor is omitted. The above-described amplifier may of course also be omitted from the first radio circuit. Also, the second low pass filter and the second capacitor may be omitted.

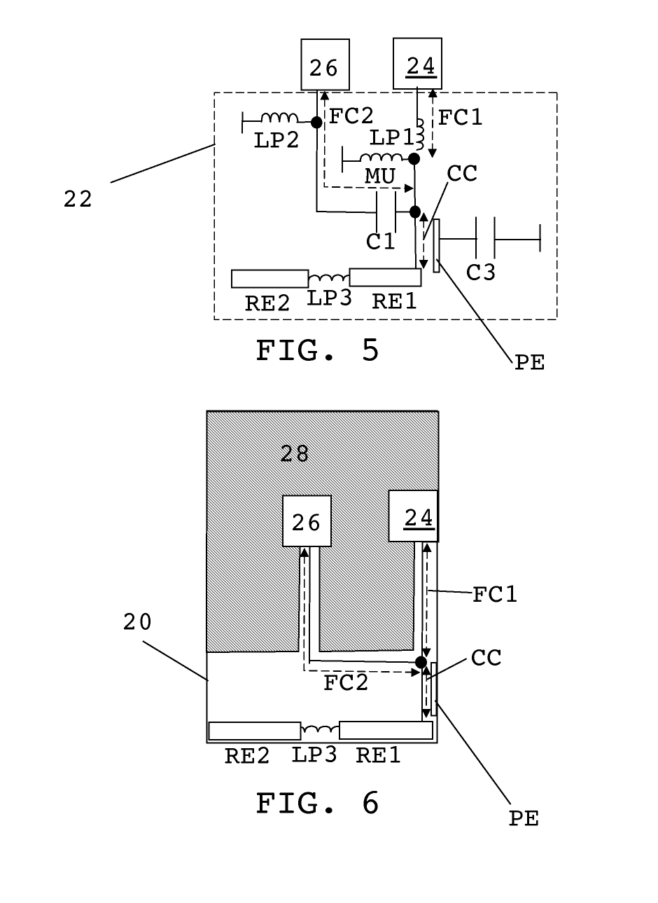

FIGS. 5 and 6 show a second exemplary embodiment of the antenna device that is provided in a similar way as FIGS. 3 and 4.

The difference from the first exemplary embodiment is that the radiator structure of the second exemplary embodiment comprises two radiator elements RE1 and RE2 provided along the short edge, i.e., the first side, of the circuit board. These radiator elements RE1 and RE2 are interconnected via a third low pass filter LP3, which can be realized in the form of an inductor, typically having a value of 30 nH, which low pass filter is arranged to let signals in the first frequency band to pass and to block signals in the second frequency band.

In this second exemplary embodiment, there is furthermore a parasitic element PE placed along the common feeding connection CC along the second long side of the circuit board. The parasitic element PE is thus provided at essentially right angles to the first and second radiator elements RE1 and RE2. This parasitic element PE is here connected to ground via a third capacitor C3. The capacitor C3 is set for grounding the parasitic element PE in the second and higher frequency bands but not in the first frequency band. This parasitic element PE has the function of providing high band resonance.

In the second exemplary embodiment, the first and second radiator elements RE1 and RE2 are together provided all along the short side of the circuit board. They are thus connected in series after each other along this short side for providing operation in the first frequency band, where the third low pass filter LP3 ensures that the first and second radiator elements are considered as one single element. They can therefore together be considered as one element for providing resonance in the first frequency band. But the filter LP3 also ensures that the second radiator element RE2 does not contribute to the operation in the second frequency band. Therefore, only the first radiator element RE1 contributes to resonance in this band. It can thus be seen that in this second exemplary embodiment the second end of the first radiator element RE1 is floating or not connected to any potential in relation to the second frequency band. Thus, in this second exemplary embodiment, the radiator structure functions as a monopole element in both the first and the second frequency band.

Also, here the radiator elements stretch along the whole of the short side and are fed from the long side as in the first exemplary embodiment. Also the second exemplary embodiment also has the sum of the shunt capacitors connected to the radiator structure below 15 pF. But in this second exemplary embodiment, there is only one such capacitor, the first capacitor C1, and therefore it is enough that this capacitor has a value below 15 pF.

There are a number of variations that can be made also of this second exemplary embodiment. Also, here the matching inductor can be removed and the first radio circuit can include an amplifier or be provided without. It is here also possible to add the second capacitor, provide or omit an amplifier in or from the first radio circuit as well as to omit the second low pass filter. It is also possible to remove the parasitic element.

Here, it is also possible that the radiator structure is used as a PIFA antenna for the cellular bands. In this case, there might be needed a further ground connection at the first end of the radiator structure, which should also be provided via a capacitor. In this case also, this additional capacitor has to be considered in the comparison with the limit of 15 pF.

In case the radiator structure is not DC grounded, it is possible to provide such DC grounding through a large resistor, typically of about 560 kilohms (kS2), between the radiator structure and ground. This resistor may be connected to the first end of the radiator structure.

A number of different embodiments and variations have been disclosed. It should be realized that these are but just a few ways in which the antenna device may be varied. For example, the radiator structure need not be stretching along a short side. It may instead be stretching along a long side of the circuit board. The second feeding connection need not be made coupled to the radiator structure at the first end. It can be coupled anywhere along the length of the radiator structure between the first and the second ends. It is furthermore possible to connect more radio circuits to the radiator structure. In this case, they may be connected with a feeding connection including a series-capacitor and preferably with means for setting the second end of this capacitor connection to ground in the first frequency band, for example, using a low pass filter. Then this capacitance would have to be considered when performing the above-mentioned summing.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An antenna device for operation in at least a first lower and a second higher frequency band, the antenna device comprising:
a radiator structure including at least one first radiator element and having a first and a second end;
a first feeding connection coupling the radiator structure to a first radio circuit for operation in the first frequency band;
a second feeding connection coupling the radiator structure to a second radio circuit for operation in the second frequency band;
a set of capacitors connected to the radiator structure and including at least one capacitor, where a first end of each capacitor in the set is connected to the radiator structure and a second end is provided at ground potential, at least for the first frequency band, and the sum of the values of the capacitors in the set is below 15 picofarads.

2. The antenna device of claim 1, further comprising a first low pass filter series-connected in the first feeding connection between the first radio circuit and the radiator structure.

3. The antenna device of claim 1, wherein the set of capacitors comprises a first capacitor connected to the radiator structure.

4. The antenna device of claim 3, wherein the first capacitor is series-connected in the second feeding connection.

5. The antenna device of claim 3, further comprising a second low pass filter connected between the second end of the first capacitor and ground.

6. The antenna device of claim 1, wherein the set of capacitors comprises a second capacitor connected between the second end of the radiator structure and ground.

7. The antenna device of claim 1, wherein the radiator structure comprises a second radiator element coupled to the first radiator element via a third low pass filter.

8. The antenna device of claim 1, wherein the radiator structure has a length corresponding to the whole length of a first side of a circuit board of a portable radio communication device.

9. The antenna device of claim 8, wherein the first side is a short side of the circuit board.

10. The antenna device of claim 8, further comprising a common feeding connection joining the first and the second feeding connections to the radiator structure, the common feeding connection being configured to stretch at right angles to the longitudinal extension of the radiator structure along a second side of the circuit board.

11. The antenna device of claim 10, further comprising a parasitic element placed adjacent the common feeding connection.

12. The antenna device of claim 11, further comprising a third capacitor connected between the parasitic element and ground.

13. The antenna device of claim 1, further comprising a matching unit connected between the first feeding connection and ground.

14. The antenna device of claim 1, further comprising a resistor connected between the radiator structure and ground.

15. The antenna device of claim 1, wherein antenna device includes one or more low pass filters designed for allowing signals in the first frequency band and blocking signals in the second frequency band.

16. The antenna device of claim 1, wherein the first radio circuit includes an amplifier, and wherein the capacitors of the set, radiator structure, and any other electrical components connected to the radiator structure provide an impedance that is close to the optimal noise impedance of the amplifier in the first frequency band.

17. The antenna device of claim 1, wherein:
the first frequency band is the FM band; and/or
the second frequency band includes at least one cellular frequency band.

18. A portable radio communication device comprising in its interior:
an antenna device of claim 1;
a circuit board; and
a first and a second radio circuit connected to the antenna device.

19. The portable radio communication device of claim 18, wherein the radiator structure is provided above a part of the circuit board lacking a ground plane.

20. The portable radio communication of claim 18, wherein:
the circuit board has a first side; and
the radiator structure stretches along the whole length of this first side.
